(19) United States
(12) Patent Application Publication
(10) Pub. No.: US 2012/0127202 A1
(43) Pub. Date: May 24, 2012

(54) SYSTEM AND METHOD FOR PROVIDING DELIVERY INFORMATION

(75) Inventors: Yong Hoon CHOI, Daejeon (KR); Hyeon Guk KIM, Chungcheongnam-do (KR); Jae Gwan SONG, Daejeon (KR); Dong Ho KIM, Daejeon (KR); Hoon JUNG, Daejeon (KR); Jong Heung PARK, Daejeon (KR)

(73) Assignee: ELECTRONICS AND TELECOMMUNICATIONS RESEARCH INSTITUTE, Daejeon (KR)

(21) Appl. No.: 13/204,312

(22) Filed: Aug. 5, 2011

(30) Foreign Application Priority Data
Nov. 24, 2010 (KR) 10-2010-0117711

(51) Int. Cl. G09G 5/00

(52) U.S. Cl. 345/633

(57) ABSTRACT

Provided are a system and a method for logistics delivery using augmented reality, which are used for efficient logistics delivery through generation of an optimal delivery route and improvement of a delivery rate. The present invention is constituted by a mobile terminal which is used by a delivery man, a logistics information system, and a mobile communication company's server. When the delivery man scans an image in a delivery scheduled area by using the mobile terminal, a mobile apparatus displays detailed delivery information regarding a delivery point in an area for each set area unit and whether a customer is positioned in the vicinity of an address and generates the optimal delivery route.

### CROSS-REFERENCE TO RELATED APPLICATIONS

This application claims priority to and the benefit of Korean Patent Application No. 10-2010-0117711 filed in the Korean Intellectual Property Office on Nov. 24, 2010, the entire contents of which are incorporated herein by reference.

### TECHNICAL FIELD

The present invention relates to a system and a method for providing delivery information. More particularly, the present invention relates to a system and a method for providing delivery information by using augmented reality (AR).

### BACKGROUND

In general, delivery men who perform logistics such as a home-delivery service, a postal service, and the like establish a delivery route through their experiences when they start or arrive in a predetermined area with a great quantity of delivery articles loaded on their vehicles. In this case, personnel who is in charge of a new delivery area undergoes a difficulty in understanding routes or distribution characteristics of the corresponding area and should spend a lot of time on being familiar with them. Further, the personnel should perform an additional service such as revisiting or consigning a delivery article to a guardroom when a receiving customer is absented and willingly submit to inconvenience such as individually making a call in advance in order to prevent such a trouble. Accordingly, a method for effectively performing a large quantity of logistics is required.

### SUMMARY

The present invention has been made in an effort to provide a system and a method for providing delivery information that generate an optimal route for effectively delivering a large quantity of articles by using augmented reality and location detecting technology.

An exemplary embodiment of the present invention provides a logistics delivery system by using augmented reality that displays detailed delivery information regarding delivery points, e.g., a detailed address, an addressee's name, a virtual phone number, an article name, and the like, and an optimal delivery route in an area for each set area unit, e.g., for each building or each block by using augmented reality technology when an article delivery man goes to a delivery target area and scans an image of a scheduled delivery area and includes a mobile terminal generating address mapping information regarding the delivery points in the area with an image recognizing unit and a GPS module, a logistics information system comparing the delivery area mapping information received from the mobile terminal with a list of scheduled delivery addresses and providing the corresponding detailed delivery information and the optimal route to the mobile terminal, and a mobile communication company's server verifying whether a receiving customer is positioned in the vicinity of a current delivery point.

The mobile terminal may include: a communication interface used to communicate with the logistics information system; an image acquiring unit photographing an image; a GPS module determining the location of the photographed image; and an image/GPS information mapping unit combining image information and GPS positional information with each other and thereafter, generating address information corresponding to the relevant image.

The logistics information system may include: a communication interface that communicates with the mobile terminal and a mobile communication company's server; a delivery information DB including an address, an addressee and addresser's names, a phone number, an item, and the like to deliver or pick up logistics; an information comparing unit receiving the address information from the mobile terminal and comparing the received address information with a delivery and pick-up scheduled list in the delivery information DB to generate delivery or pick-up information; a virtual phone number managing unit virtually generating and storing phone numbers of an addresser and an addressee for protecting personal information; and a route generating unit optimizing and generating a sequence route of the generated delivery or pick-up addresses.

The mobile communication company's server may include; a communication interface that communicates with the logistics information system; and location verifying unit based on a cellular phone that allows the delivery man to verify whether the addressee or addresser is positioned within an allowance range adjacent to the corresponding address through the logistics information system.

Another exemplary embodiment of the present invention provides a logistics delivery method by using augmented reality, including: scanning a delivery scheduled area by using a mobile terminal when a delivery man who delivers articles reaches a predetermined area such as an apartment or a building; generating address information of a delivery point by combining an image of the scanned area and GPS information with each other and mapping an address; transmitting the generated address information to an information comparing unit of the logistics information system; comparing the address information of the delivery point received from the information comparing unit with information regarding a list of delivery or pick-up addresses in a delivery information DB; generating an optimal regular route for a matched delivery or pick-up address in a route generating unit; requesting a location verifying unit of a mobile communication company's server to verify whether a customer of the delivery or pick-up address included in the regular route is positioned in the vicinity of the address; transmitting, by the location verifying unit, whether the customer is presented in the address to the logistics information system; transmitting, by the information comparing unit, to the mobile terminal the information on the delivery and the regular route in the scanned area including whether the customer is presented; displaying, by the mobile terminal, the information including the delivery and the regular route for the delivery man to view the information on the screen by using augmented reality technology; performing, by the delivery man, the delivery in the case in which the delivery man intends to perform the delivery according to the displayed regular route regardless of whether the customer is positioned in the address or in the vicinity thereof, for example, in the case in which the delivery man consigns the article to an adjacent delivery point or keeps the article at an adjacent place which the customer desires; requesting a regular route adjustment such as deletion of the delivery point where the customer is not presented to the route generating unit of the logistics information system in the case in which the delivery man selects a future or additional delivery for a delivery point where the customer is not positioned in the address or in the vicinity thereof; adjusting and regenerating, by the route generating unit, an optimal regular route for a list of delivery points other than the corresponding delivery point; retransmitting, by the information comparing unit, the delivery information regarding the corresponding area based the adjusted regular route to the mobile terminal; and performing, by the delivery man, the delivery according to the displayed delivery information and regular route.

The present invention can provide the following effects by generating an optimal route for effectively delivering a large quantity of articles by using augmented reality and location verifying technology. First, a delivery man who delivers articles merely scans an image of a scheduled delivery area with a mobile apparatus to receive delivery information such as a delivery address of the corresponding area, addressee information, and the like, the location of a customer's address, and optimal regular delivery route information. Second, when a pick-up request is received during a delivery, a regular route can be readjusted in real time, and times and costs consumed to logistics distribution and pick-up can be remarkably reduced. Third, since an IT system supports a delivery service without relying on a delivery man's experience, even a delivery man who is newly assigned in the corresponding area can easily and effectively perform the delivery service, and as a result, opportunity costs are created and times can be saved. Fourth, the delivery man is not required to individually make a call to addressees for inquiring whether an addressee is presented in his/her home or notifying that the delivery man will revisit due to addressee's absence, causing communication costs and workloads to be reduced. Fifth, various systems such as the exclusive use of delivery, the exclusive use of pick-up, the combined use of delivery and pick-up, and the like can be utilized and effective logistics distribution can be expected.

### BRIEF DESCRIPTION OF THE DRAWINGS

FIG. 1 is a schematic block diagram of a system for providing delivery information according to an exemplary embodiment of the present invention;

FIG. 2 is a block diagram of a logistics delivery system using augmented reality according to an exemplary embodiment of the present invention;

FIG. 3 is a block diagram showing a detailed configuration example of a mobile terminal configuring a logistics delivery system;

FIG. 4 is a block diagram showing a detailed configuration example of a logistics information system configuring a logistics delivery system;

FIG. 5 is a block diagram showing a detailed configuration example of a mobile communication company' server configuring a logistics delivery system;

FIG. 6 is a flowchart showing a method for providing delivery information according to an exemplary embodiment of the present invention; and

FIG. 7 is a flowchart showing an example of a logistics delivery method in a logistics delivery system using augmented reality.

### DETAILED DESCRIPTION

Hereinafter, exemplary embodiments of the present invention will be described in detail with reference to the accompanying drawings. First of all, it should be noted that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiments of the present invention will be described, but it will be understood to those skilled in the art that the spirit and scope of the present invention are not limited thereto and various modifications and changes can be made.

Provided are a system and a method for logistics delivery using augmented reality, which are used for efficient logistics delivery through generation of an optimal delivery route and improvement of a delivery rate. The present invention is constituted by a mobile terminal which is used by a delivery man, a logistics information system, and a mobile communication company's server. When the delivery man scans an image in a delivery scheduled area by using the mobile terminal, a mobile apparatus displays detailed delivery information regarding a delivery point in an area for each set area unit and whether a customer is positioned in the vicinity of an address and generates the optimal delivery route. According to the present invention, since the optimal delivery route of delivery points of the corresponding area required for a logistics delivery and whether an addressee is positioned in the delivery point or in the vicinity thereof are determined to be notified to the delivery man, a delivery failure rate can be reduced and even a new delivery man who is assigned in the corresponding area can effectively complete a delivery service within a short time.

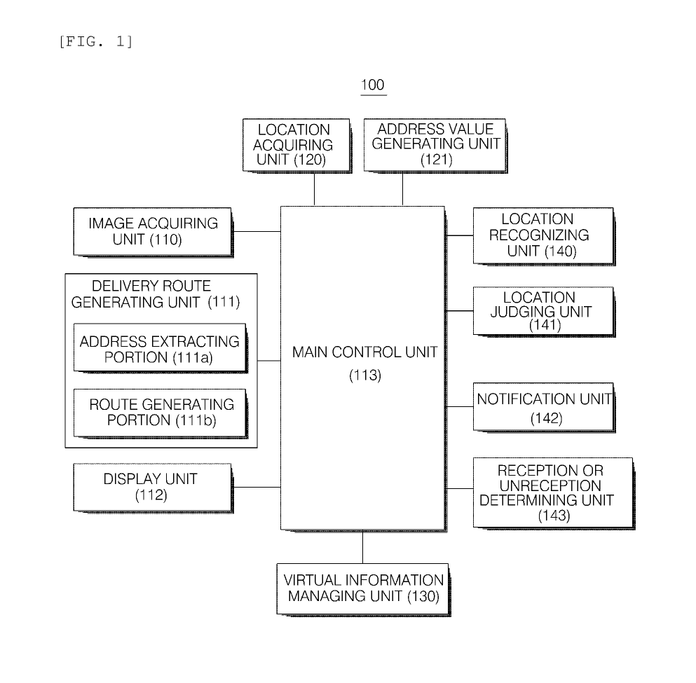

FIG. 1 is a schematic block diagram of a system for providing delivery information according to an exemplary embodiment of the present invention. Referring to FIG. 1, the delivery information providing system 100 includes an image acquiring unit 110, a delivery route generating unit 111, a display unit 112, and a main control unit 113. The delivery information providing system 100 may provided in a apparatus, for example, mobile phone.

The image acquiring unit 110 acquires an image including at least one building. In the exemplary embodiment, the image acquiring unit 110 acquires an image by using a mobile apparatus carried by a person who delivers articles.

The delivery route generating unit 111 generates a delivery route from a current location to a destination, which is suitable for a predetermined criterion on the basis of information regarding the destination acquired from the acquired image. In the above description, the destination represents an article destination.

The display unit 112 displays the generated delivery route on a real image including both the current location and the destination. Moreover, the display unit 112 also displays whether an article receiver can receive an article.

The main control unit 113 controls an overall operation of each of the units constituting the delivery information providing system 100.

The delivery information providing system 100 may further include a location acquiring unit 120 and an address value generating unit 121. The location acquiring unit 120 acquires positional information regarding a place where the image is acquired or a building in the acquired image. The address value generating unit 121 generates an address value for at least one site included in the image by mapping the acquired positional information to the acquired image.

By considering that the delivery information providing system 100 further includes the location acquiring unit 120 and the address value generating unit 121, the delivery route generating unit 111 may include an address extracting portion 111a and a route generating portion 111b. The address extracting portion 111a extracts address information regarding the generated address value from previously stored address information. The route generating portion 111b generates a delivery route based on an article destination or the location of an article receiver on the basis of the extracted address information. In the above description, the delivery route based on the article destination may be, for example, a route up to an article delivery place. The delivery route based on the location of the article receiver may be, for example, a route up to a pick-up place with the article receiver. However, the delivery route is not necessarily limited thereto in the exemplary embodiment. The reason therefor is that the route up to the pick-up place with the article receiver may be arbitrarily designated through a call with the article receiver.

The delivery information providing system 100 may further include a virtual information managing unit 130. The virtual information managing unit 130 generates personal information regarding a person who requests sending an article or the article receiver as virtual information. In the exemplary embodiment, the virtual information managing unit 130 may generate a virtual phone number as the virtual information at the time of generating the personal information regarding the article receiver as the virtual information. In this case, the virtual information managing unit 130 converts the generated virtual phone number into an actual phone number which the article receiver is using to request the location of the article receiver when the image is acquired. And, the virtual information managing unit 130 requests the location of the article receiver. Meanwhile, the virtual information managing unit 130 deletes the generated virtual information when it is verified that the delivery of the article is completed.

By considering that the virtual information managing unit 130 requests the location of the article receiver, the delivery information providing system 100 may further include a location recognizing unit 140, a location judging unit 141, and a notification unit 142. The location recognizing unit 140 recognizes the location of the article receiver on the basis of the request from the virtual information managing unit 130. The location judging unit 141 judges whether the recognized location is within a predetermined distance from the article destination. The notification unit 142 notifies the recognized location or a judgment result value. Meanwhile, the delivery information providing system 100 may further include a reception or unreception determining unit 143. When the recognized location is received from the notification unit 142, the reception or unreception determining unit 143 judges whether the recognized location is within a predetermined distance from the article destination and thereafter, determines whether the article can be received on the basis of a result of the judgment. In contrast, when the judgment result value is received from the notification unit 142, the reception or unreception determining unit 143 determines whether the article can be received on the basis of the judgment result value.

Meanwhile, the delivery information providing system 100 may further include a receivability judging unit (not shown). The receivability judging unit judges whether the article can be received on the basis of the generated virtual information. The receivability judging unit performs an automatic dialing function to the virtual phone number when the virtual phone number is generated as the virtual information. Thereafter, when a user inputs a predetermined value on the basis of a dialogue content, the receivability judging unit may judge whether the article can be received according to the input value or judge whether the article can be received by analyzing the dialogue content through voice recognition.

Next, an exemplary embodiment of the delivery information providing system will be described. The delivery information providing system according to the exemplary embodiment as a logistics delivery system using augmented reality generates detailed delivery information regarding a delivery destination within an area for each set area unit, whether a customer is positioned in the vicinity of an address, and an optimal delivery route, and the like and displays the generated information by using augmented reality technology when a delivery man who delivers articles goes to a delivery target area and scans an image of a scheduled delivery area with a mobile apparatus having a GPS module and a camera. According to this system, the delivery man obviously verifies a delivery list of the corresponding area through a terminal and may perform an effective delivery on the spot. In the above description, the area unit may be based on, for example, a building or a block and the detailed delivery information includes a detailed address, a receiver's name, a virtual phone number, an article name, and the like.

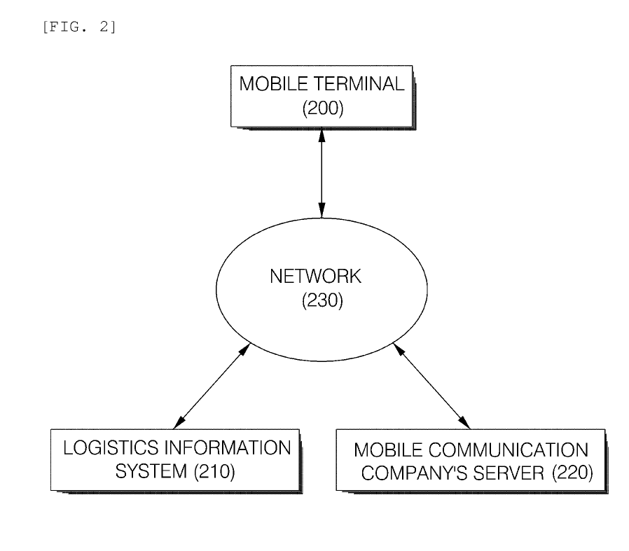

An effective method without a complex process for the logistics delivery will be described below. FIG. 2 is a block diagram of a logistics delivery system using augmented reality according to an exemplary embodiment of the present invention.

A mobile terminal 200 includes a GPS module and a camera and transmits an image and positional information mapped with an address to a logistics information system 210. Further, the mobile terminal 200 displays detailed delivery information received from the logistics information system 210. The mobile terminal 200 includes a communication interface, an image acquiring unit, a GPS module, and an image/GPS information mapping unit. The communication interface is used to communicate with the logistics information system 210. The image acquiring unit photographs an image. The GPS module determines the location of the photographed image. The image/GPS information mapping unit combines image information and GPS positional information with each other and thereafter, generates address information corresponding to the relevant image. A more detailed description of an internal configuration of the mobile terminal 200 refers to the following description.

The logistics information system 210 compares delivery area mapping information received from the mobile terminal 200 with a list of delivery scheduled addresses and provides the corresponding detailed delivery information and route to the mobile terminal 200. The logistics information system 210 includes a communication interface, a delivery information database (DB), an information comparing unit, a virtual phone number managing unit, and a route generating unit. The communication interface communicates with the mobile terminal 200 and a mobile communication company's server 220. The delivery information DB stores information including an address to deliver or pick up logistics, an addressee or addresser's name, a phone number, an item, and the like. The information comparing unit receives the address information from the mobile terminal 200 and compares the received address information with a delivery and pick-up scheduled list in the delivery information DB to generate delivery or pick-up information. The virtual phone number managing unit virtually generates and stores phone numbers of an addresser and an addressee for protecting personal information. The route generating unit optimizes and generates a sequence route of the generated delivery or pick-up addresses. A more detailed description of an internal configuration of the logistics information system 210 refers to the following description.

The mobile communication company's server 220 represents a mobile communication company's server and verifies whether a receiving customer is positioned adjacent to a delivery destination at present. The mobile communication company's server 220 includes a communication interface and a location verifying unit. The communication interface communicates with the logistics information system 210. The location verifying unit is the cellular phone based unit that allows the delivery man to verify whether the addressee or addresser is positioned within an allowance range adjacent to the corresponding address through the logistics information system 210. A more detailed description of an internal configuration of the mobile communication company's server 220 refers to the following description.

The mobile terminal 200 carried by the delivery man is connected with the logistics information system 210 and the mobile communication company's server 220 through the network 230. The mobile terminal 200, the logistics information system 210, and the mobile communication company's server 220 include their own basic software and hardware and since Internet communication between components generally uses known Internet communication technology, a detailed description thereof will be omitted.

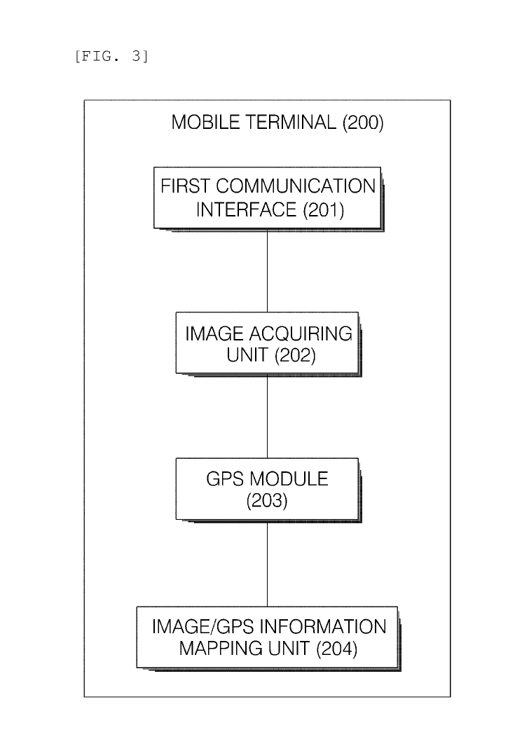

FIG. 3 is a block diagram showing a detailed configuration example of a mobile terminal 200. The mobile terminal 200 includes a first communication interface 201, an image acquiring unit 202, a GPS module 203, and an image/GPS information mapping unit 204.

The first communication interface 201 communicates with the logistics information system 210 and the mobile communication company's server 220 by using the network 230.

The image acquiring unit 202 acquires image information of the corresponding area at the time when the mobile terminal 200 intends to acquire image information of a building or an area to which logistics will be delivered.

The GPS module 203 acquires positional information regarding the image information of the building or area which the image acquiring unit 202 acquires.

The image/GPS information mapping unit 204 generates the address information by combining and mapping the image information and the positional information and transmits the generated address information to the logistics information system 210 through the first communication interface 201.

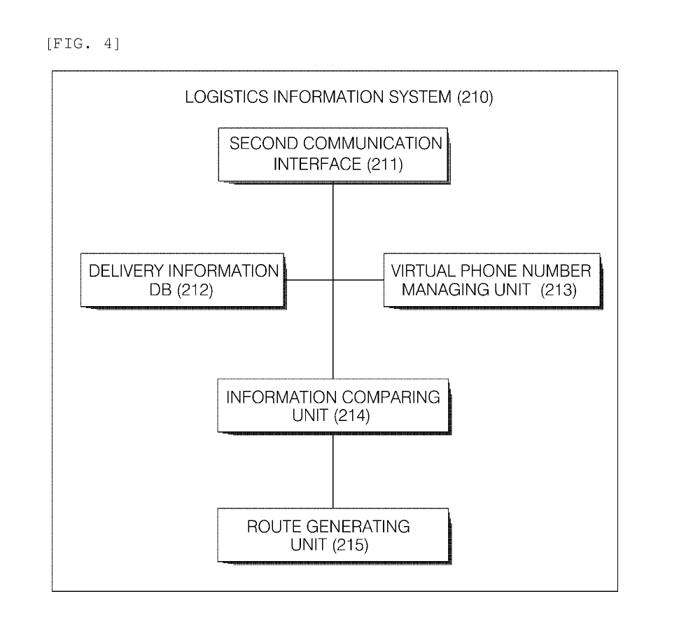

FIG. 4 is a block diagram showing a detailed configuration example of a logistics information system 210. The logistics information system 210 includes a second communication interface 211, a delivery information DB 212, a virtual phone number managing unit 213, an information comparing unit 214, and a route generating unit 215.

The second communication interface 211 communicates with the mobile terminal 200 and the mobile communication company's server 220 by using the network 230.

The delivery information DB 212 includes information regarding an address, a name, and a phone number of an addresser/addressee, and an item with respect to logistics to be delivered or picked up.

The virtual phone number managing unit 213 virtually generates and displays the phone number of the addresser/addresser displayed on an invoice attached to an article to be delivered and the mobile terminal 200 for a single use in order to prevent personal information from being leaked and automatically deletes the phone number after the delivery is completed. Further, when a delivery man scans a predetermined building or area on the mobile terminal 200, the virtual phone number managing unit 213 converts a virtual phone number of delivery address information included in the corresponding area into an actual phone number to request whether a customer is positioned at the delivery address to the mobile communication company's server 220.

The information comparing unit 214 compares delivery or pick-up address information on the delivery information DB 212 with the address information received from the mobile terminal 200 through the second communication interface 211 to generate a list of matched addresses.

The route generating unit 215 generates an optimal regular route including the delivery or pick-up with respect to the address list generated by the information comparing unit 214 and transmits the generated optimal regular route to the mobile terminal 200 through the second communication interface 211.

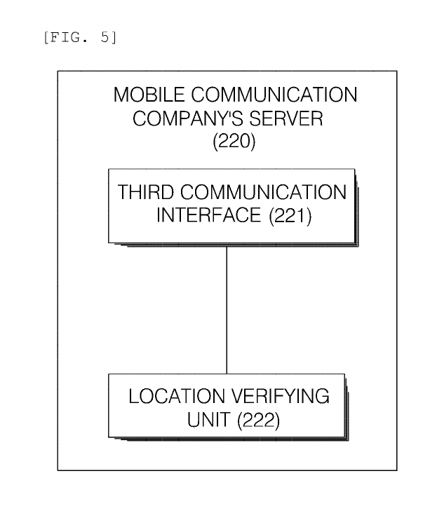

FIG. 5 is a block diagram showing a detailed configuration example of a mobile communication company's server 220. The mobile communication company's server 220 includes a third communication interface 221 and a location verifying unit 222.

The third communication interface 221 communicates with the logistics information system 210 by using the network 230.

When the location verifying unit 222 is requested to verify whether a logistics addressee is positioned in a delivery address or in the vicinity thereof by means of a cellular phone number from the logistics information system 210 through the third communication interface 221, the location verifying unit 221 verifies whether the logistics addressee is positioned in the delivery address or in the vicinity thereof and notifies the verification result to the logistics information system 210.

According to the exemplary embodiment, when a delivery man who is in charge of logistics delivery scans a delivery scheduled area with the mobile terminal, delivery information including an address, an addressee, a virtual phone number, an item, and the like are displayed on a screen in the case in which an article to be delivered or picked up exists in the corresponding area and simultaneously an optimal regular route is displayed together with information indicating that the delivery can be made with respect to a delivery point or a delivery point positioned in the vicinity thereof of an addressee corresponding to the displayed virtual phone number on the basis of augmented reality, and as a result, time and cost that are consumed for delivery can be reduced.

Meanwhile, the reason for using the virtual phone number is that customer's personal information, e.g., the cellular phone number is exposed to the invoice attached to the article and the delivery man cause the personal information to be leaked. Therefore, the virtual phone number is randomly generated in the logistics information system. The virtual phone number is deleted at the time when the delivery is completed. Further, in regards to tracking the location of a receiving customer or a sending customer, only information indicating that the delivery man can directly deliver an article to the customer is provided because the customer is positioned in the address or in the vicinity thereof when the delivery man delivers the article at present without providing actual customer's positional information to the delivery man by not verifying whether the customer is presented in the corresponding address but merely verifying whether the customer is presented in a predetermined range of the corresponding area. Therefore, since the delivery man does not need to consign an important article to a guardroom or an adjacent place and individually verify whether the customer is presented in the address, it can be effective in terms of cost and time.

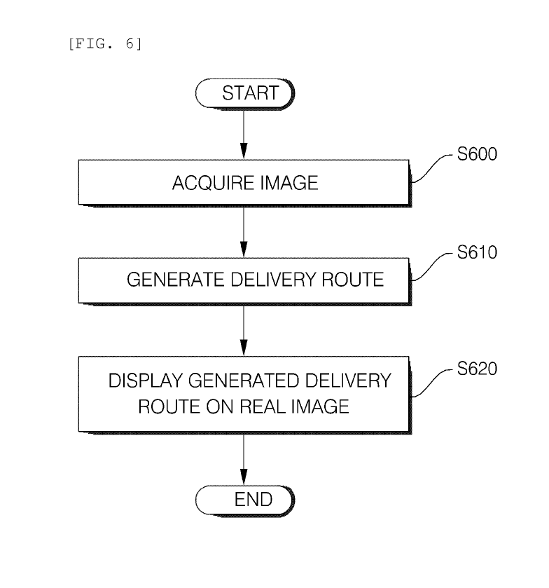

Next, a delivery information providing method of the delivery information providing system 100 will be described. FIG. 6 is a flowchart showing a method for providing delivery information according to an exemplary embodiment of the present invention. The following description refers to FIG. 6.

First, an image including at least one building is acquired (an image acquiring step, S600). In the image acquiring step (S600), a person who delivers an article acquires the image by using a portable mobile apparatus. Thereafter, a delivery route up to a destination from a current location suitable for a predetermined criterion is generated based on information on the destination acquired from the acquired image (a delivery route generating step, S610). Thereafter, the generated delivery route is displayed on a real image including both the current location and the destination and whether an article receiver can receive the article is displayed (a displaying step, S620).

A location acquiring step and an address value generating step may be performed as middle steps between the image acquiring step (S600) and the delivery route generating step (S610). In the location acquiring step, positional information regarding a place where the image is acquired or a building in the acquired image is acquired. In the address value generating step, an address value for at least one point included in the image is generated by mapping the acquired positional information to the acquired image.

In the case in which the location acquiring step and the address value generating step are performed, the delivery route generating step (S610) may be subdivided into an address extracting step and a route generating step. In the address extracting step, address information regarding the generated address value is extracted from previously stored address information. In the route generating step, a delivery route based on the location of an article destination or an article receiver is generated on the basis of the extracted address information.

A virtual information managing step may be performed before the image acquiring step (S600). In the virtual information managing step, personal information regarding a person who requests sending an article or an article receiver is generated as virtual information. In the exemplary embodiment, the virtual information managing step may be performed as a middle step between the image acquiring step (S600) and the delivery route generating step (S610).

In the virtual information managing step, a virtual phone number may be generated as the virtual information at the time of generating the personal information regarding the article receiver as the virtual information. In this case, in the virtual information managing step, the generated virtual phone number is converted into an actual phone number which the article receiver is using to request the location of the article receiver after the image is acquired. Meanwhile, in the virtual information managing step, when it is verified that the delivery of the article is completed, the generated virtual information is deleted.

In consideration of requesting the location of the article receiver in the virtual information managing step, a location recognizing step, a location judging step, and a notification step may further be performed. In the location recognizing step, the location of the article receiver is recognized based on the request. In the location judging step, it is judged whether the recognized location is within a predetermined distance from the article receiver. In the notification step, the recognized location or the judgment result value is notified. The location recognizing step, the location judging step, and the notification step are performed after the virtual information managing step and may be performed as a middle step of the image acquiring step and the delivery route generating step. Meanwhile, after the notification step, a reception or unreception determining step may further be performed. In the reception or unreception determining step, when the recognized location is received, it is judged whether the recognized location is within a predetermined distance from the article receiver and thereafter, it is determined whether the article can be received on the basis of the judgment result and when the judgment result value is received, it is determined whether the article can be received on the basis of the judgment result value.

Meanwhile, a receivability judging step may be performed after the virtual information managing step. In the receivability judging step, it is judged whether the article can be received on the basis of the generated virtual information.

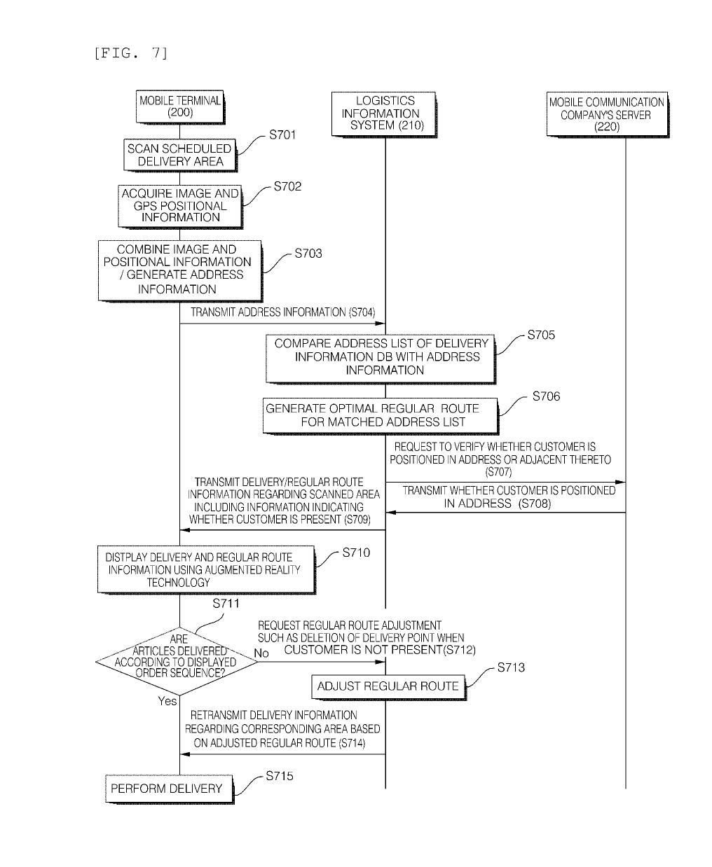

Next, as one example of the delivery information providing step, a logistics delivery method using augmented reality will be described. FIG. 7 is a diagram showing an example of a logistics delivery method in a logistics delivery system using augmented reality. The logistics delivery method of FIG. 7 is a flowchart showing a process of providing delivery and optimal regular route information when a delivery man scans a delivery scheduled area in a delivery site.

The logistics delivery method according to an exemplary embodiment may include a first step in which a delivery man who delivers a plurality of articles scans an image in a delivery scheduled area by using a mobile terminal, a second step of generating address information of a delivery point by combining an image of the scanned area and GPS information with each other and mapping an address, a third step of transmitting the generated address information to an information comparing unit of the logistics information system, a fourth step of comparing the address information of the delivery point received from the information comparing unit with information regarding a list of delivery or pick-up addresses in a delivery information DB, a fifth step of generating an optimal regular route for a matched delivery or pick-up address in a route generating unit, a sixth step of requesting a location verifying unit of a mobile communication company's server to verify whether a customer of the delivery or pick-up address included in the regular route is positioned in the vicinity of the address, a seventh step of transmitting whether the customer is presented in the address to the logistics information system in the location verifying unit, an eighth step of processing a delivery address in which the customer is not positioned in the address or in the vicinity thereof as a future delivery and readjusting a regular delivery route for the rest addresses, a ninth step of transmitting final delivery information to a mobile terminal by adding additional information of the delivery information DB to the address information on the regular delivery route, and a tenth step of displaying the regular route information including the delivery information received through the mobile terminal to be viewed to the delivery man by using augmented reality. A more detailed description will be made below.

First, when the delivery man who delivers articles reaches a predetermined area such as an apartment or a building, the delivery man scans a delivery scheduled area by using the mobile terminal (S701). When the delivery man scans the corresponding area, the image acquiring unit and the GPS module acquire image information and GPS based positional information regarding the corresponding image information (S702). Thereafter, the image/GPS information mapping unit combines the image information and the positional information with each other and generates address information corresponding thereto (S703). Thereafter, the generated address information is transmitted to the logistics information system 210 through the first communication interface (S704).

The information comparing unit of the logistics information system 210 compares the address list in the delivery information DB with the address information received from the mobile terminal 200 (S705). After comparison, the route generating unit generates the optimal regular delivery route for the matched address list (S706). The virtual phone number managing unit having the actual phone number of the addresser/addressee and the virtual phone number generated for a single use requests the location verifying unit of the mobile communication company's server 220 to verify whether the customer is positioned in the address or in the vicinity thereof through the second communication interface by using the actual phone number corresponding to the virtual phone number of the addressee (S707).

The location verifying unit transmits whether the customer is presented in the address to the logistics information system 210 through the third communication interface (S708).

The information comparing unit transmits the delivery and regular route information of the scanned area including the information indicating whether the customer is presented to the mobile terminal 200 through the second communication interface (S709).

The mobile terminal 200 displays the delivery and regular route information to be viewed to the delivery man through the screen by using the augmented reality technology (S710). In the case in which the delivery man intends to perform the delivery according to the displayed regular route regardless of whether the customer is positioned in the address or in the vicinity thereof (S711), for example, in the case in which the delivery man consigns the article to an adjacent delivery point or keeps the article at an adjacent place which the customer desires, the delivery man performs the delivery (S715). In the case in which the delivery man selects a future or separate delivery for a delivery point where the customer is not positioned in the address or in the vicinity thereof (S711), regular route adjustment such as deletion of the delivery point where the customer is not presented is requested to the route generating unit of the logistics information system 210. In this case, the route generating unit adjusts and regenerates an optimal regular route for a list of delivery points other than the corresponding delivery point (S713). Thereafter, the information comparing unit retransmits the delivery information regarding the corresponding area based the adjusted regular route to the mobile terminal 200 (S714). Thereafter, the delivery man performs the delivery according to the displayed delivery information and regular route (S715).

The present invention is implemented by combining augmented reality technology and location recognizing technology with the existing logistics delivery system and since a delivery man can obviously verify a delivery list of a corresponding area on a terminal and perform an effective delivery on the spot, the present invention is expected to contribute to improve the existing logistics delivery system.

The spirit of the present invention has been just exemplified. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A system for providing delivery information, comprising:
an image acquiring unit acquiring an image including at least one building;
a delivery route generating unit generating a delivery route from a current location to a destination, which is suitable for a predetermined criterion on the basis of information regarding the destination acquired from the acquired image; and
a display unit displaying the generated delivery route on a real image including both the current location and the destination and displaying whether an article receiver can receive an article.

2. The system of claim 1, further comprising:
a location acquiring unit acquiring positional information regarding a place where the image is acquired or a building in the acquired image; and
an address value generating unit generating an address value for at least one site included in the image by mapping the acquired positional information to the acquired image.

3. The system of claim 2, wherein the delivery route generating unit includes:
an address extracting portion extracting address information regarding the generated address value from previously stored address information; and
a route generating portion generating the delivery route based on an article destination or the location of an article receiver on the basis of the extracted address information.

4. The system of claim 1, further comprising a virtual information managing unit generating personal information regarding a person who requests sending an article or the article receiver as virtual information.

5. The system of claim 4, wherein the virtual information managing unit generates a virtual phone number as the virtual information at the time of generating the personal information regarding the article receiver as the virtual information and converts the generated virtual phone number into an actual phone number which the article receiver is using to request the location of the article receiver when the image is acquired.

6. The system of claim 5, further comprising:
a location recognizing unit recognizing the location of the article receiver on the basis of the request;
a location judging unit judging whether the recognized location is within a predetermined distance from the article destination; and
a notification unit notifying the recognized location or a judgment result value.

7. The system of claim 6, further comprising the reception or unreception determining unit judging whether the recognized location is within a predetermined distance from the article destination when the recognized is received and thereafter determining whether the article can be received on the basis of a result of the judgment, and determining whether the article can be received on the basis of the judgment result value when the judgment result value is received.

8. The system of claim 4, wherein the virtual information managing unit deletes the generated virtual information when it is verified that the delivery of the article is completed.

9. The system of claim 1, wherein the image acquiring unit acquires the image by using a mobile apparatus carried by a person who delivers the article.

10. The system of claim 4, further comprising a receivability judging unit judging whether the article is received on the basis of the generated virtual information.

11. A method for providing delivery information, comprising:
acquiring an image including at least one building;
generating a delivery route from a current location to a destination, which is suitable for a predetermined criterion on the basis of information regarding the destination acquired from the acquired image; and
displaying the generated delivery route on a real image including both the current location and the destination and displaying whether an article receiver can receive an article.

12. The method of claim 11, further comprising:
acquiring positional information regarding a place where the image is acquired or a building in the acquired image; and
generating an address value for at least one site included in the image by mapping the acquired positional information to the acquired image.

13. The method of claim 12, wherein the generating of the delivery route includes:
extracting address information regarding the generated address value from previously stored address information; and
generating the delivery route based on an article destination or the location of an article receiver on the basis of the extracted address information.

14. The method of claim 11, further comprising generating personal information regarding a person who requests sending an article or the article receiver as virtual information.

15. The method of claim 14, wherein in the managing of the virtual information, a virtual phone number is generated as the virtual information at the time of generating the personal information regarding the article receiver as the virtual information and the generated virtual phone number is converted into an actual phone number which the article receiver is using to request the location of the article receiver when the image is acquired.

16. The method of claim 15, further comprising:
recognizing the location of the article receiver on the basis of the request;
judging whether the recognized location is within a predetermined distance from the article destination; and
notifying the recognized location or a judgment result value.

17. The method of claim 16, further comprising judging whether the recognized location is within a predetermined distance from the article destination when the recognized is received and thereafter determining whether the article can be received on the basis of a result of the judgment, and determining whether the article can be received on the basis of the judgment result value when the judgment result value is received.

18. The method of claim 14, wherein in the managing of the virtual information, the generated virtual information is deleted when it is verified that the delivery of the article is completed.

19. The method of claim 11, wherein in the acquiring of the image, the image is acquired by using a mobile apparatus carried by a person who delivers the article.

20. The method of claim 14, further comprising judging whether the article is received on the basis of the generated virtual information.
